(19) United States
(12) Patent Application Publication
(10) Pub. No.: US 2010/0089128 A1
(43) Pub. Date: Apr. 15, 2010

(54) APPARATUS FOR LEAKAGE TESTING AND/OR PRESSURE TESTING OF A PORTION OF A PIPE AND ALSO A METHOD FOR USE OF SAME

(76) Inventors: Jan Kristian Vasshus, Sandnes (NO); Geir Ueland, Sola (NO); Trond Melhus, Sandnes (NO)

Correspondence Address: GABLE & GOTWALS, 100 WEST FIFTH STREET, 10TH FLOOR, TULSA, OK, 74103, US

(21) Appl. No.: 12/519,843

(22) PCT Filed: Dec. 19, 2007
(86) PCT No.: PCT/NO2007/000452

§ 371 Date: Jul. 14, 2009

(30) Foreign Application Priority Data
Dec. 20, 2006 (NO) 20065970

(51) Int. Cl. G01M 3/28; E21B 47/10

(52) U.S. Cl. 73/40.5 R; 166/250.08; 73/49.5

(57) ABSTRACT

The present invention relates to an apparatus (1) for leakage testing and/or pressure testing a portion of a pipe (7), the apparatus (1) including at least two spaced-apart packer elements (3, 5) which are arranged to define a volume (10) of fluid in an annulus between said at least two packer elements (3, 5) and the internal jacket surface of the pipe (7), and the apparatus (1) being provided with a means for providing a differential pressure between the fluid volume (10) and a fluid located immediately upstream and downstream of the apparatus (1), and with a means for sensing the pressure of the fluid volume (10). The invention also relates to a method of using the apparatus.

The present invention relates to an apparatus for and a method of leakage testing and/or pressure testing a pipe. More particularly, it relates to an apparatus for and a method of leakage testing and/or pressure testing one or more portions of a pipe string which is used in, for example, a well in connection with the recovery of oil and gas.

Even though an apparatus and a method for use in the leakage testing and/or pressure testing of a portion of a pipe in a well are largely discussed in what follows, it will be understood that the apparatus and method according to the present invention could be used in connection with the leakage testing and/or pressure testing of any pipe arranged to carry fluid.

A pipe string in a well could include well-lining pipes and extension pipes disposed below the well-lining pipes. Well-lining pipes and extension pipes will be known to a person skilled in the art as “casing” and “liner”, respectively. Correspondingly, the joining portion between a casing and a liner will be known as a “liner lap”. These terms might also be used in the present document.

The present invention could be used both in connection with leakage testing and in the pressure testing of a pipe string in, for example but not limited to, a well. For simplicity, only the term leakage testing will be used in what follows, even though the term should be understood to include, possibly, pressure testing.

A skilled person will also know the importance of the pipe string in, for example, a petroleum well being fluid-tight and that in particular gas leakages could represent a safety hazard.

When leakage testing a pipe string which includes casings and liners and joining portions between them, it is known to run a so-called test or service packer into a casing. How far the test packer is run into the pipe will vary, but the running-in is typically to a mid portion of the casing.

In the cases in which a drilling rig is installed above the well, the test packer with associated equipment is normally run into the well by means of a drill pipe. Coiled tubing or a snubbing unit is also used in the cases in which a drilling rig is not installed.

After the packer has been set, a possibility is provided for leakage testing the pipes upstream and downstream of the packer in turn. Details as to how such leakage tests are carried out will be well known to a person skilled in the art and will not be mentioned any further herein.

There are several drawbacks related to the above-mentioned prior art.

Running a packer into a well by means of drill pipe is time-consuming and could typically take 24-48 hours. In addition, the work represents labour-intensive operations involving, in addition, many heavy equipment lifting operations. This represents an element of risk to operators involved in the work. In addition, the operations will involve considerable costs.

By setting the test packer in the casing, there could be defined a volume downstream of the packer and a volume upstream of the packer. The volume upstream of the packer, that is below the packer in a vertical well, will include the joint between the casing and the liner, the so-called “liner lap”. If, during leakage testing, a leak is revealed upstream of the packer, it will not be possible to establish whether the leak is in the joint between the pipes, for example in said liner lap, or whether the leak is at some other point up-stream of the packer. Thus, further and time-consuming operations will be required to be able to establish more precisely where the leak is located. If it is established that the leak is somewhere in the liner, the test packer must be removed from the well and a new and smaller test packer adjusted to the dimension of the liner must be inserted into the well. This will, in turn, involve further time spent and labour-intensive operations.

A further drawback of the prior art leakage testing relates to the accuracy of the testing. It has turned out to be challenging to reveal relatively small leakages in the large volume of fluids that are placed under pressure. Thus, a result of acceptable accuracy requires relatively long pressure holding times, which in turn entails drawbacks in terms of resources.

The invention has for its object to remedy or reduce at least one of the drawbacks of the prior art.

The object is achieved through features which are specified in the description below and in the claims that follow.

In a first aspect of the invention there is provided an apparatus for the pressure and leakage testing of at least a portion of a pipe, the apparatus including at least two spaced-apart packer elements which are arranged to define a volumetric amount of fluid in the annulus between said at least two packer elements and the internal jacket surface of the pipe, the apparatus being provided with means for providing a differential pressure between the fluid volume and a fluid located immediately upstream and downstream of the apparatus, and with means for sensing the pressure of the fluid volume.

In a preferred embodiment the at least two packer elements are repeatable. That is, the packers can be expanded and contracted several times. Thereby is achieved the advantageous feature that several different portions of a pipe could be pressure-tested successively without the apparatus having to be pulled out of, for example, a well.

In one embodiment the at least two packer elements comprise a first packer element of a first diameter and a second packer element of a second diameter, the first diameter being substantially equal to the second diameter. Such an embodiment is of interest when the apparatus is to be inserted into a portion of a pipe of a substantially uniform diameter.

In one embodiment the at least two packer elements comprise a first packer element of a first diameter and a second packer element of a second diameter, the first diameter being larger than the second diameter. Such an embodiment is of interest when the apparatus is to be used to leakage-test or pressure-test for example a joining portion between, for example, a casing and a liner.

In a preferred embodiment at least one of the at least two packer elements is connected to a reservoir of fluid arranged to communicate into and out of the at least one fluid volume between the at least two spaced-apart packer elements, whereby said differential pressure is provided.

The reservoir of fluid is preferably disposed in a portion of the apparatus.

It is an advantage if at least the pressure, but also other parameters which are measured in said at least one fluid volume, can be recorded and/or communicated out of the well in a manner known per se, preferably but not necessarily, substantially in real time.

In a preferred embodiment there are placed, immediately up-stream and downstream of the apparatus, measuring devices which could at least measure the pressure of the fluid in the pipe.

It is an advantage if the measuring results from the measurements carried out immediately upstream and downstream of the apparatus can be recorded and/or communicated out of the well in a manner known per se, preferably but not necessarily, substantially in real time.

In one embodiment the apparatus is further provided with devices for sensing temperature in the fluid present in the fluid volume between the packer elements and/or immediately upstream and downstream of the apparatus, so that changes in fluid pressure in consequence of changes in the temperature of the fluid could be compensated for and not erroneously indicate a fluid leakage. Such compensation could be calculated by means of, for example but not limited to, a piece of software known per se, which is run on a computer.

In one embodiment the apparatus is further provided with a flow-measuring device which is arranged to measure fluid flow out of the fluid volume between the packer elements. Such a measuring device could provide useful information on the size of a possible leakage. Corresponding measuring devices could also be disposed immediately upstream and downstream of the apparatus.

The apparatus could be run in and out of the well by the apparatus being placed in a portion of the pipe string. However, as mentioned initially, this would be time-consuming and, thereby, costly. Therefore, the apparatus is arranged to be inserted into the well by means of a so-called eline/wireline, a coiled tubing, a so-called “slick line” or a downhole tractor.

When a leak is revealed, it is an advantage if the leak can be sealed and then pressure-tested again without the apparatus having to be pulled from the well. Therefore, in a preferred embodiment, the apparatus is further provided with a leak-sealing means which is arranged to be selectively released from the apparatus.

In a first embodiment, the leak-sealing means could be constituted by a fluid known per se, which is arranged to form a barrier in the leakage area. The fluid could be accommodated in a portion of the apparatus and, whenever necessary, be communicated out of the apparatus to the leakage area.

In a second embodiment the leak-sealing means is constituted by a mechanical sealing means positioned initially in a portion of the apparatus. Whenever necessary, the sealing means could be released from the apparatus by means of a release mechanism known per se and carried in a manner known per se into sealing contact with the portion of the pipe where the leakage is revealed. The mechanical sealing means is formed by, for example but not limited to, a sleeve portion which is swaged into sealing contact with a portion of the pipe.

In a third embodiment the leak-sealing means is formed by a combination of said fluid and said mechanical means.

Preferably, the apparatus according to the present invention is module-based. This means that, for example, one packer dimension could easily be replaced with another packer dimension without other components needing to be replaced.

In a second aspect the present invention is formed by a method of leakage testing and/or pressure testing a portion of a pipe, in which an apparatus which includes at least two spaced-apart packer elements arranged to define at least one volumetric amount of fluid in the annulus between said at least two packer elements and the internal jacket surface of the pipe, is positioned in a predetermined portion of the pipe, there being provided in said volume of fluid a differential pressure between the fluid volume and a fluid located immediately upstream and downstream of the apparatus, the differential pressure being monitored to reveal any change in the differential pressure over time.

In what follows, there is described an example of a preferred embodiment which is visualized in the accompanying drawings, in which:

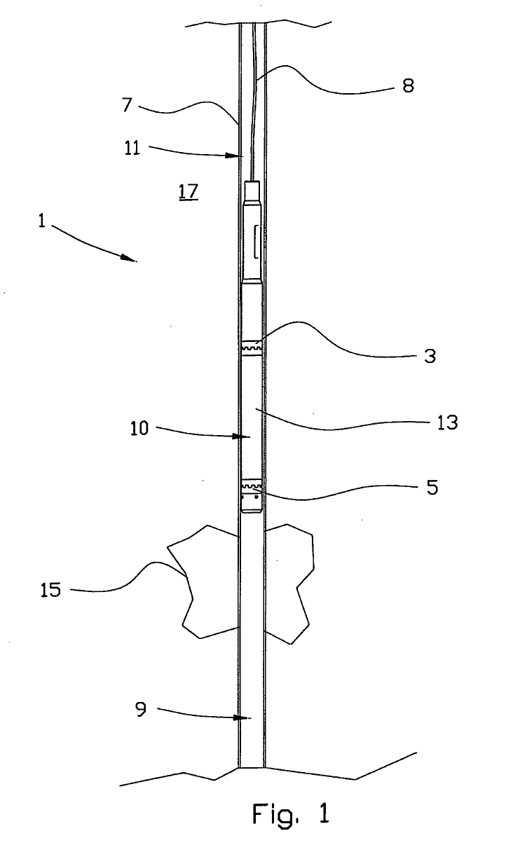

FIG. 1 shows a view of a first embodiment of an apparatus according to the present invention including two spaced-apart packers, the apparatus being moved within a casing;

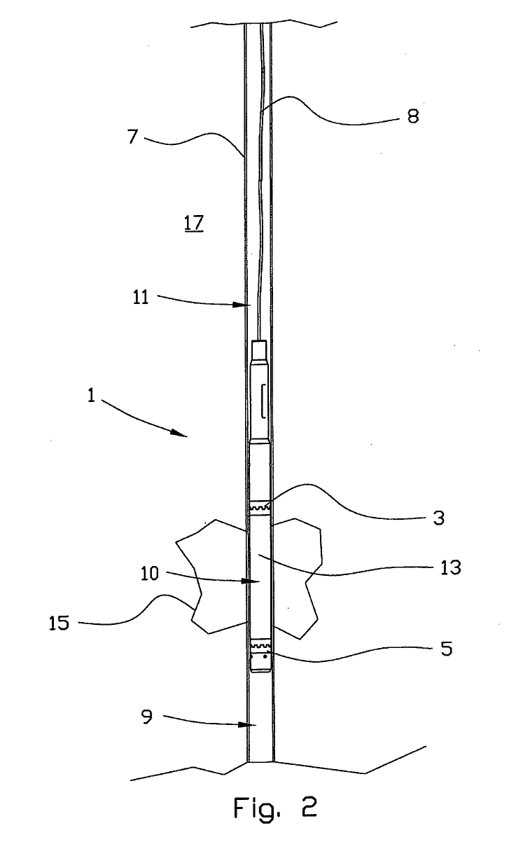

FIG. 2 shows a view of the apparatus of FIG. 1, the apparatus being positioned in a weakened zone of the formation around the casing;

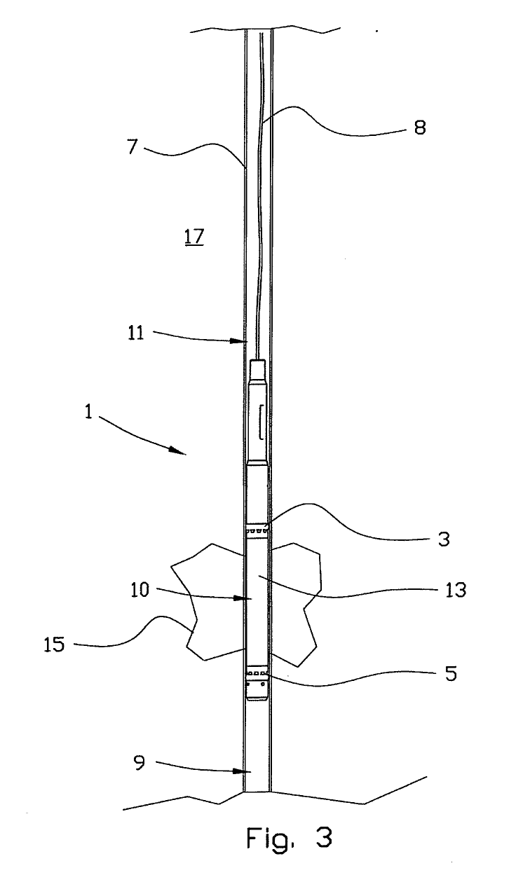

FIG. 3 shows a view of the apparatus of FIG. 2, the packers having been set;

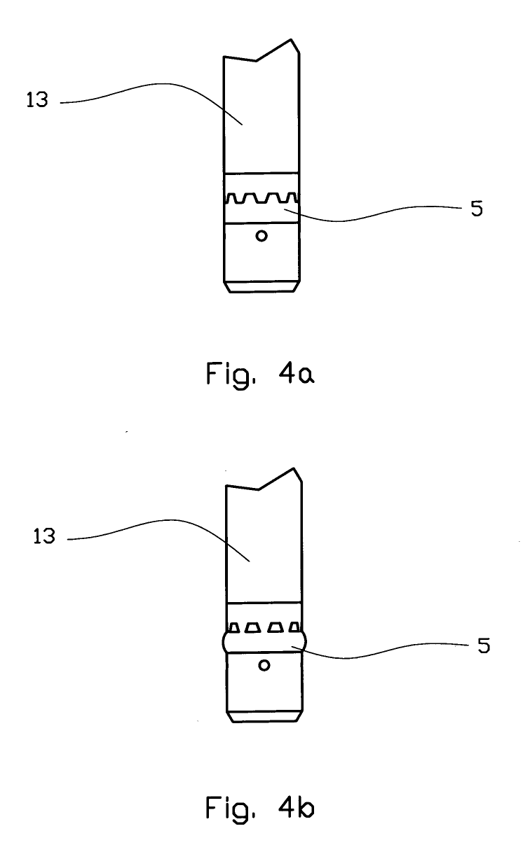

FIG. 4a shows, on a larger scale, a detail of the lower packer element of FIG. 2;

FIG. 4b shows, on a larger scale, a detail of the lower packer element of FIG. 3;

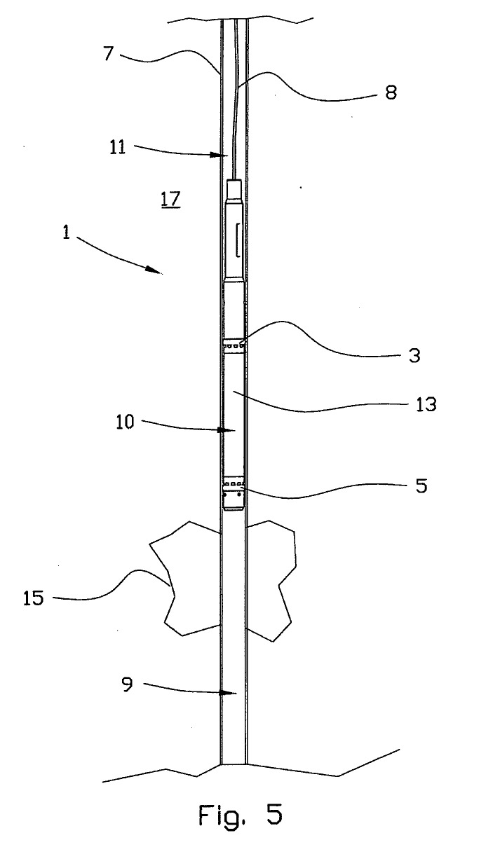

FIG. 5 shows, on a smaller scale, the apparatus as it has been pulled higher up in the well and set in a portion above the weakened zone; and

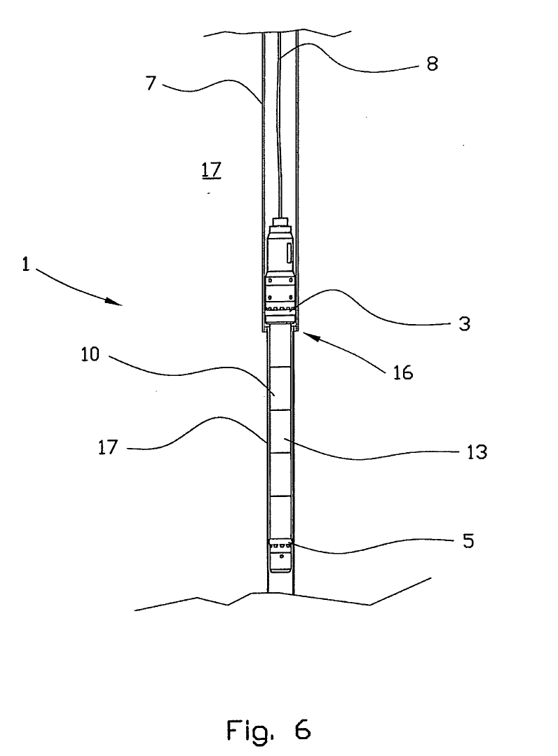

FIG. 6 shows a view of a second embodiment of an apparatus according to the present invention, the apparatus being placed at the so-called liner lap, and the packer elements being set in the casing and in the liner.

In the figures the reference numeral 1 identifies an apparatus which is provided with a first packer element 3 and a second packer element 5. The apparatus 1 is arranged to be inserted into a well pipe string 7. For simplicity, the well pipe string 7 will be referred to hereinafter as the pipe string 7.

When the apparatus 1 has been carried to the desired position within the well pipe string 7, one or both packer elements 3, 5 can be expanded into abutment with a respective portion of the internal jacket surface of the pipe string 7.

FIG. 1 shows the apparatus 1 as it is arranged to be moved inside the pipe string 7. The packer elements 3, 5 of the apparatus 1 are in a non-activated or contracted position. The apparatus 1 is run into and pulled out of the pipe string 7 by means of a so-called e-line/wireline 8 which is attached, in a manner known per se, to an upper portion of the apparatus 1.

The packer elements 3, 5 of the apparatus 1 shown in the FIGS. 1 to 3 and 5 are of substantially the same diameter and are arranged to be expandable into abutment against an internal portion of the pipe 7 which has a substantially uniform internal diameter. Such a pipe 7 may be a casing, for example.

After the apparatus 1 has been placed in a desired position within the pipe string 7, see FIG. 2, the first packer element 3 and the second packer element 5 may be expanded, each separately or both, into abutment with the internal jacket surface of the pipe string 7, see FIG. 3.

The packer elements 3, 5 are set in a manner known per se, by means of, for example but not limited to, a hydraulic force provided by means of an aggregate (not shown) which is preferably disposed in a portion of the apparatus 1. In a preferred embodiment the aggregate is arranged to be controlled from the surface, for example via the electrical cable 8, the so-called e-line.

To be able to provide reliable retention of the apparatus 1 within the well pipe 7, the apparatus is provided with at least one anchor, not shown but known per se, or slips. The at least one anchor is set and disengaged in a manner which will be well known to a person skilled in the art, and will therefore not be described any further herein.

After the packer elements 3, 5 have been set, three fluid volumes 9, 10, 11 are defined in the pipe string; a first fluid volume 9 upstream of the apparatus 1 (being, for a producing well, below the apparatus 1 in the figures); a second fluid volume 10 which is defined in the annulus between the packer elements 3, 5, the internal jacket surface of the pipe string 7 and a housing part or mandrel 13 of the apparatus 1; and a third fluid volume 11 downstream of he apparatus 1 (being, for a producing well, above the apparatus 1).

The apparatus 1 is provided with three sensors (not shown) of a kind known per se, which are arranged at least to be able to sense and record the fluid pressure of said three fluid volumes 9, 10, 11.

Leakage testing or pressure testing upstream or downstream of the apparatus 1 is carried out in a manner known per se by pressurizing the first fluid volume 9 and the third fluid volume 11, respectively, to a defined pressure. Any change in pressure in the course of the dwell time indicates a fluid leakage between the pipe string 7 and the formation outside the pipe string 7. A skilled person will know that during pressure testing, the first fluid volume 9 downstream of the apparatus 1 will have to be defined by means of a valve (not shown).

It should be noted that the above-mentioned leakage testing or pressure testing of the first volume 9 and third volume 11 could be carried out by setting just one of the packer elements 3, 5. Leakage testing in which just one of the packer elements 3 or 5 are set, will have strong similarities to prior art leakage testing.

The first fluid volume 9 and second fluid volume 11 are very much larger than the second fluid volume 10 defining the volume between the packer elements 3, 5 and the internal jacket surface of the pipe string 7.

Thus, a small leak in the pipe string 7 could be detected more easily by leakage testing the second fluid volume 10. For the same reason the necessary dwell time could be reduced considerably by leakage testing the second fluid 10, compared to leakage testing the first fluid volume 9 or third fluid volume 11.

Experience goes to show that a leakage is more likely in the part of, for example, a casing 7 extending through a weakened zone 15 than in the part of the casing 7 surrounded by a solid formation 17. Therefore, a leakage test of the casing 7 will preferably be carried out first by positioning the apparatus as shown in FIG. 3.

If no leakage is established between the casing 7 and the weakened zone 15, the fluid volumes 9 and 11 upstream and downstream, respectively, of the apparatus 1 can be leakage-tested.

If a leakage is established in the third volume 11 downstream of the apparatus 1, the apparatus 1 can be pulled higher up within the casing 7 and the packers 3, 5 set anew, so that a new second volume 10 is defined, see FIG. 5, just above the previous defined second volume 10, shown in FIG. 3.

In that way, the leakage testing can be repeated until, possibly, a leakage is established between the first and second packer elements 3, 5 of the apparatus.

After a leakage has been established, sealing means (not shown) can be released from the apparatus as described earlier.

In FIG. 6 is shown an alternative embodiment of an apparatus 1 which is provided with packer elements 3, 5 of different diameters. The apparatus 1 is configured for leakage testing the critical joining portion 16 between a casing 7 and a and a liner 17, the so-called “liner lap”.

With the exception of the first packer element 3 having a larger diameter than the second packer element 5, the apparatuses shown in, for example, FIG. 1 and in FIG. 6 are alike. However, the apparatus 1 shown in FIG. 6 is not suitable for defining a second fluid volume 10 in a portion of the casing 7. If the apparatus 1 of FIG. 6 is provided with a further packer element (not shown) having the same diameter as one of the packer elements 3, 5, a limited fluid volume could be provided, which could be leakage-tested in a quick and reliable manner.

It will be understood that the apparatus 1 according to the present invention could be provided with a so-called fishing neck (not shown) for the connection of fishing equipment known per se.

Further, it will be understood that the apparatus could also be provided with a device (not shown) for the connection of a downhole tractor which could move the apparatus 1 through portions of the well in which it cannot be carried by means of gravity.

Thus, the present invention provides an apparatus which can be positioned in a simple and quick way in a desired portion of a well, and in which a possible leakage area could be established relatively accurately compared to the prior art.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. An apparatus for testing a portion of a pipe, said apparatus comprising at least two mutually spaced-apart packer elements arranged in a manner allowing them to define a first fluid volume upstream of the apparatus, a second fluid volume in an annulus between said at least two packer elements and an internal jacket surface of the pipe and a third fluid volume downstream of the apparatus,
wherein said apparatus is provided with an aggregate arranged in a manner allowing it to provide a differential pressure across at least one of the packer elements and allowing it to activate and deactivate at least one packer element to and from engagement with the internal jacket surface of the pipe;
wherein said packer elements are arranged in a manner allowing them to be selectively set independent of each other; and
wherein said apparatus further is provided with a means to sense a fluid pressure in the second fluid volume and in at least one of said first fluid volume and said third fluid volume.

18. The apparatus in accordance with claim 17, further comprising said aggregate is controlled by means of an e-line.

19. The apparatus in accordance with claim 17, further comprising said aggregate arranged in a manner allowing it to provide the differential pressure by means of a fluid source placed within the apparatus.

20. The apparatus in accordance with claim 17, further comprising said aggregate arranged in a manner allowing it to provide the differential pressure by means of fluid located upstream or downstream of the apparatus.

21. The apparatus in accordance with claim 17, further comprising at least one flow-measuring device arranged in a manner allowing it to measure a potential flow from at least one of the fluid volumes.

22. The apparatus in accordance with claim 17, said at least two packer elements comprising a first packer element having a first diameter and a second packer element having a second diameter, wherein the first diameter being larger than the second diameter.

23. The apparatus in accordance with claim 17, further comprising at least one device for sensing of temperature in a fluid located in the annulus and immediately upstream and downstream of the apparatus, thereby allowing for compensation of changes in fluid pressure due to changes in temperature of the fluid.

24. The apparatus in accordance with claim 17, further comprising a leak-sealing means arranged in a manner allowing it to be selectively released from the apparatus.

25. The apparatus in accordance with claim 24, said leak-sealing means comprising a fluid.

26. The apparatus in accordance with claim 24, said leak-sealing means comprising a mechanical sealing means.

27. The apparatus in accordance with claim 24, said leak-sealing means comprising a fluid and a mechanical sealing means.

28. A method of testing a portion of a pipe, said method comprising the steps of:
placing an apparatus having a first packer element and a second packer element in a desired portion of the pipe;
setting at least one of the packer elements so as to define at least two fluid volumes; and
providing a differential pressure across at least one of the packer elements, said differential pressure being monitored to be able to reveal any change in the differential pressure over time.

29. The method in accordance with claim 28, further comprising the portion of the pipe is in a casing in a well, the apparatus being provided, prior to insertion in the well, with packer elements having substantially the same diameter.

30. The method in accordance with claim 28, further comprising placing a first packer element in a portion of a casing and placing a second packer element in a portion of a liner;
wherein the apparatus, prior to insertion in the well, is provided a first packer element having a first diameter and a second packer element having a second diameter being smaller than the first diameter,

31. The method in accordance with claim 28, further comprising providing a differential pressure;
wherein the packer elements are connected to a reservoir with fluid arranged in a manner allowing it to communicate into and out of at least one fluid volume between the at least two spaced-apart packer elements.

32. The method in accordance with claim 28, further comprising testing at least two portions of the pipe successively without pulling the apparatus out of the pipe.
